(19) United States
(12) Patent Application Publication
(10) Pub. No.: US 2013/0087496 A1
(43) Pub. Date: Apr. 11, 2013

(54) Disposable filtering unit

(71) Applicant: Yao-Tung Chen, Taoyuan County (TW)

(72) Inventor: Yao-Tung Chen, Taoyuan County (TW)

(21) Appl. No.: 13/317,105

(22) Filed: Oct. 11, 2011

(51) Int. Cl. B01D 35/04; B01D 35/30

(52) U.S. Cl. 210/433.1

(57) ABSTRACT

A disposable filtering unit includes a tube having a connection portion and an outlet respectively located on two ends thereof, and the connection portion is connected to a faucet body. The tube has a first path unit and a second path unit which has a filtering unit. A valve unit is located on a side of the tube so as to change direction of water flow to guide water to enter the first path unit and flow out from the outlet, or to enter the second path unit and flow out from the outlet via the filtering unit. The tube can be disengaged from the faucet body and disposable, and the filtering unit filters water to ensure that the water is clean.

### BACKGROUND OF THE INVENTION

(1) Field of the Invention The present invention relates to a filtering unit, and more particularly, to a disposable filtering unit connected with a faucet body to form the outlet unit of the fucet body.

(2) Description of the Prior Art

The modern industrialized world generates plenty of pollutants which exist in air and water. For the water pollution, the tap water involves many germs, fine sands, Chloride, heavy metal, and pesticides. The tap water is filtered by way of Reverse Osmosis, Ozone Sterilization, Active-carbon Filtering and Ion Exchange. However, the above mentioned methods for filtering or processing water are expensive, bulky, power-consuming, or replacing filtering cores frequently. Besides, as shown in FIG. 7, another filtering method is equipping a filterer 102 directly to the outlet 101 of the faucet 100 so that when the tap water passing through the filter 102, the water is filtered. Nevertheless, the filter occupies space and cannot meet aesthetic purpose. Germs are easily attached in the filter and cores have to be replaced regularly. This is an economic burden for the users.

The present invention intends to provide a filtering unit which mitigates the shortcomings of the conventional filtering equipments.

### SUMMARY OF THE INVENTION

The present invention relates to a disposable filtering unit and comprises a tube having a connection portion and an outlet respectively located on two ends thereof, and the connection portion is connected to a faucet body. The tube has a first path unit and a second path unit which has a filtering unit. A valve unit is located on a side of the tube so as to change direction of water flow to guide water to enter the first path unit and flow out from the outlet, or to enter the second path unit and flow out from the outlet via the filtering unit.

The tube is connected to the faucet body of the faucet and the water flow can be controlled to pass through the filtering unit or not. The tube can be disengaged from the faucet body and disposable, and the filtering unit filters water to ensure that the water is clean.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the disposable filtering unit of the present invention;

FIG. 2 is a perspective view to show the disposable filtering unit of the present invention;

FIG. 3 is an exploded view to show the disposable filtering unit of the present invention connected with another faucet body;

FIG. 4 is a perspective view to show the disposable filtering unit of the present invention and the faucet body in FIG. 3;

FIG. 5 is across sectional view to show the water flow in the disposable filtering unit the present invention;

FIG. 6 is across sectional view to show another status of the water flow in the disposable filtering unit the present invention, and

FIG. 7 shows the conventional filtering faucet.

### DETAILED DESCRIPTION OF THE PREFERRED EMBODIMENTS

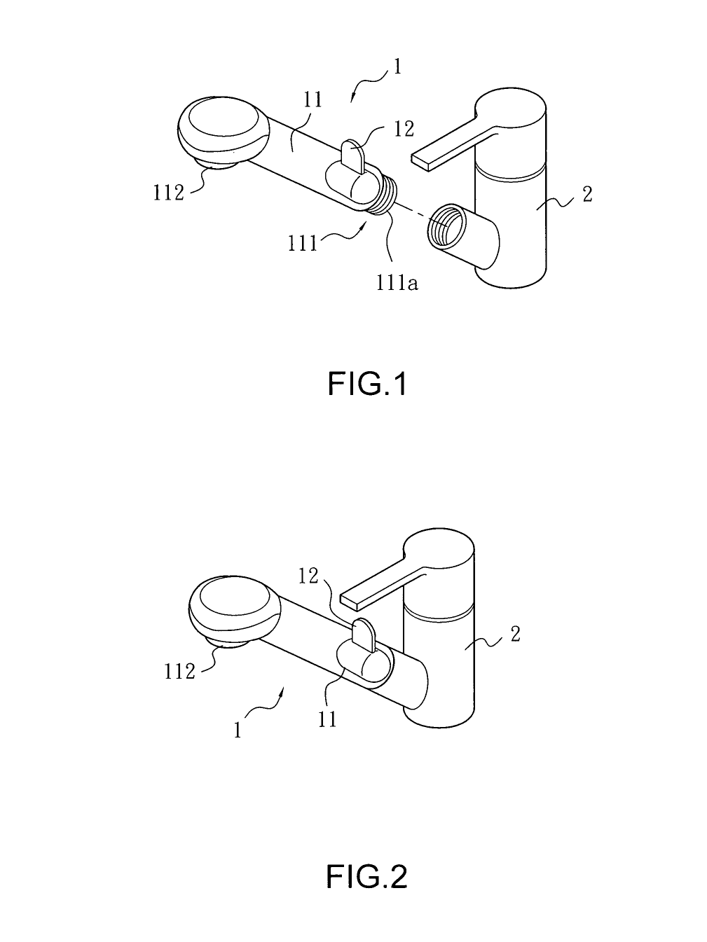

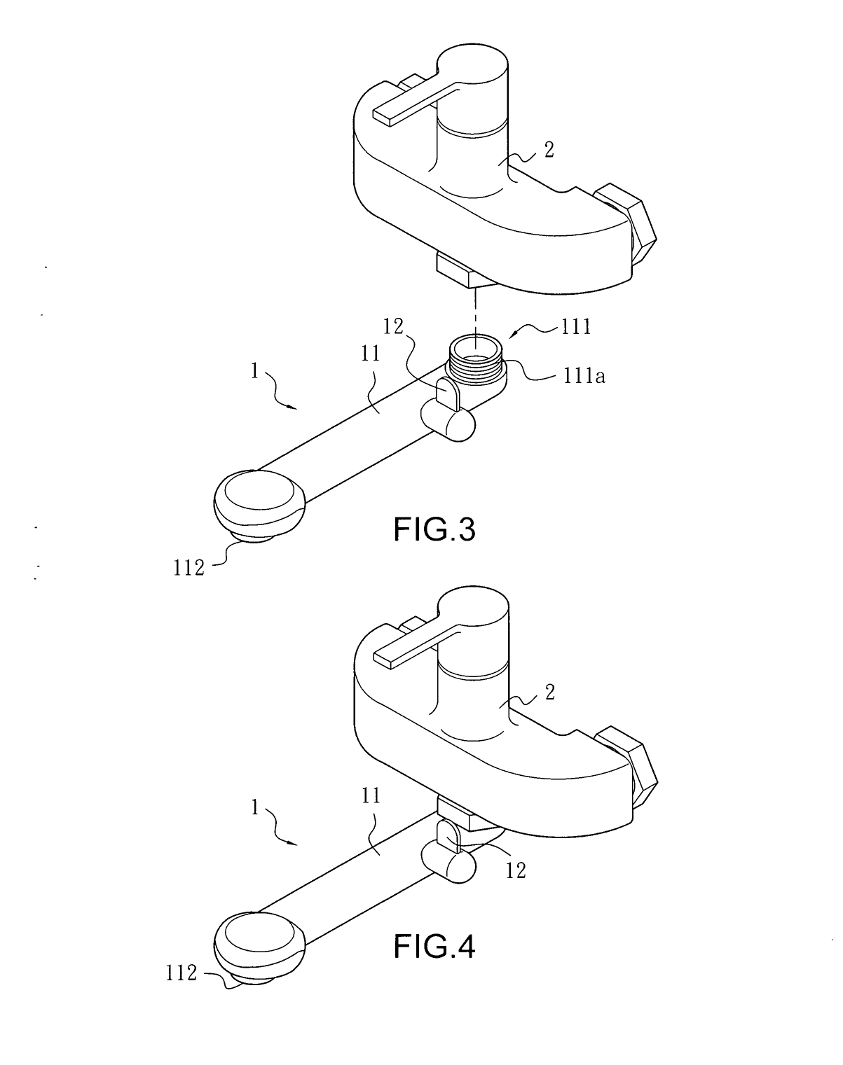

Referring to FIGS. 1 to 6, the disposable filtering unit 1 of the present invention comprises a tube 11 and a valve unit 12, wherein the tube 11 is a non-permeable tube which means water cannot enters into the tube 11 via the wall of the tube such as plastic tube. A connection portion 111 and an outlet 112 are respectively on two ends of the tube 11. The connection portion 111 is connected to a faucet body 2. The tube 11 has a first path unit 113 and a second path unit 114. The first path unit 113 has a first path 113a which is controlled by the sealing valve 121 to open and close, and the second path unit 114 has a second path 114a which is controlled by the sealing valve 121 to open and close. The second path unit 114 has a filtering unit 13. The filtering unit 13 is one or more than one of Polypropylene fibers, resins, active carbons, cottons, coals, de-chlorine agents or Porphyries Andesite. In this embodiment, the connection portion 111 has threads 111a which are connected to the faucet body 2. By the threads 111a, the tube 11 is connected to the faucet body 2 as one-piece and the disposable filtering unit becomes the outlet tube of the faucet body 2.

The valve unit 12 is located on a side of the tube 11 so as to change direction of water flow to guide water to enter the first path unit 113 and flow out from the outlet 112, or to enter the second path unit 114 and flow out from the outlet 112 via the filtering unit 13. The valve unit 12 has a sealing valve 121 which control the close or open of the first path 113a of the first path unit 113 and the second path 114a of the second path unit 114.

By the threads 111a, the tube 11 is easily connected to the faucet body 2 as one-piece and the valve unit 12 controls the direction of the water flow to pass through the filtering unit or not. When the filtering unit 13 is to be replaced, the disposable filtering unit can be easily separated from the faucet body 2 by operation of the connection portion 111.

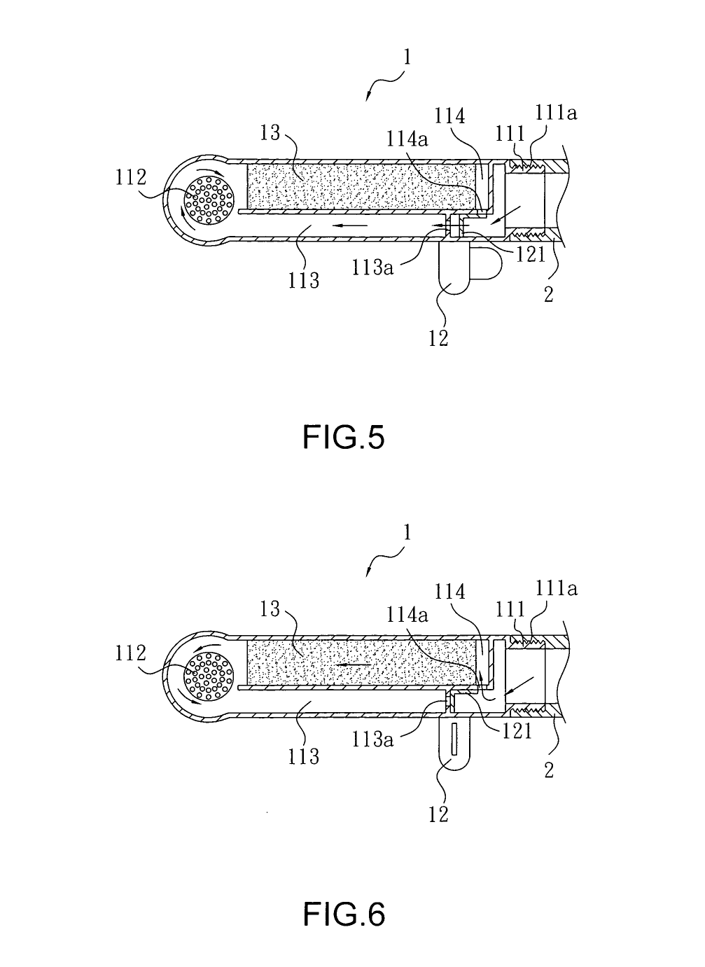

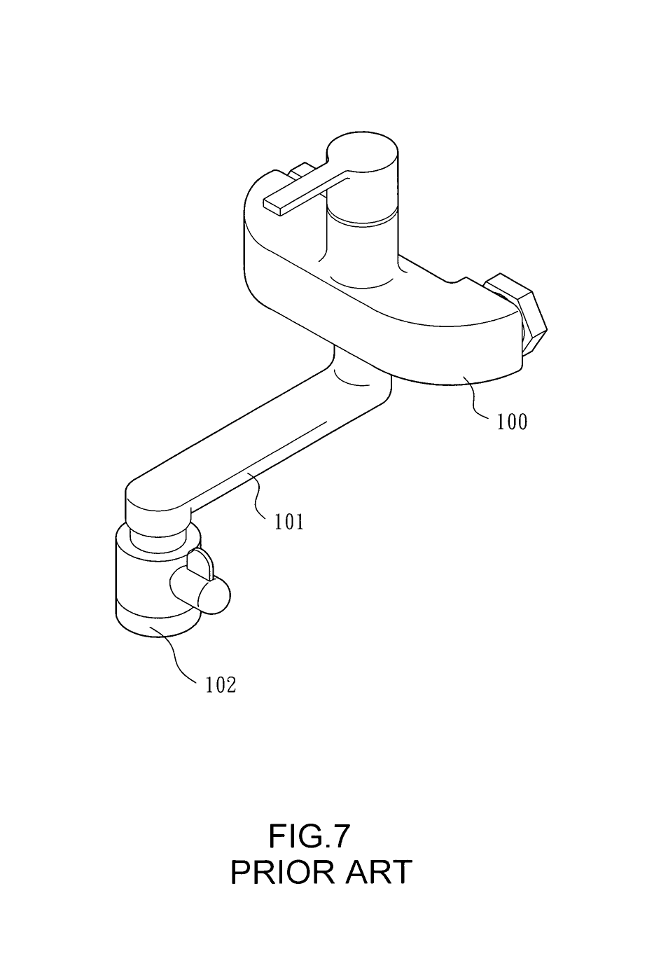

When the users want to obtain filtered water, the valve unit 12 is operated to close the first path 113a by the sealing valve 121 so that the water flows into the second path unit 114 via the second path 114a, and the water is filtered by passing through the filtering unit 13 and flows out from the outlet 112 as shown in FIG. 6. When the users do not need the tap water to be filtered, the valve unit 12 is operated to close the second path 114a by the sealing valve 121 so that the water flows into the first path unit 113 via the first path 113a, and the unfiltered water flows out from the outlet 112 as shown in FIG. 5.

The present invention has the following advantages:

The disposable filtering unit 1 is not an extra part to the faucet body 2 so that the combination meets the aesthetic purposes. By the threads 111a, the disposable filtering unit 1 is easily connected to or removed from the faucet body 2. The disposable filtering unit 1 can be disposable which is convenient for the users. The disposable filtering unit 1 can be discarded without worry about accumulation of germs and ugly water scales on the outside thereof.

While we have shown and described the embodiment in accordance with the present invention, it should be clear to those skilled in the art that further embodiments may be made without departing from the scope of the present invention.

What is claimed is:

1. A disposable filtering unit comprising:
a tube having a connection portion and an outlet respectively located on two ends thereof, the connection portion connected to a faucet body, the tube having a first path unit and a second path unit, the second path unit having a filtering unit, and
a valve unit located on a side of the tube so as to change direction of water flow to guide water to enter the first path unit and flow out from the outlet, or to enter the second path unit and flow out from the outlet via the filtering unit.

2. The disposable filtering unit as claimed in claim 1, wherein the valve unit has a sealing valve.

3. The disposable filtering unit as claimed in claim 2, wherein the first path unit has a first path which is controlled by the sealing valve to open and close.

4. The disposable filtering unit as claimed in claim 2, wherein the second path unit has a second path which is controlled by the sealing valve to open and close.

5. The disposable filtering unit as claimed in claim 1, wherein the connection portion has threads which are connected to the faucet body.

6. The disposable filtering unit as claimed in claim 1, wherein the filtering unit is one or more than one of Polypropylene fibers, resins, active carbons, cottons, coals, de-chlorine agents or Porphyries Andesite.

7. The disposable filtering unit as claimed in claim 1, wherein the tube is non-permeable tube.
